(19) United States
(12) Patent Application Publication
(10) Pub. No.: US 2024/0394557 A1
(43) Pub. Date: Nov. 28, 2024

(54) ACCELERATING AUTOMATED ALGORITHM CONFIGURATION USING HISTORICAL PERFORMANCE DATA

(71) Applicant: Oracle International Corporation, Redwood Shores, CA (US)

(72) Inventors: Yasha Pushak, Vancouver (CA); Mobina Mahdavi, Vancouver (CA); Ali Asgari Khoshouyeh, Vancouver (CA); Ali Seyfi, Vancouver (CA); Zahra Zohrevand, Vancouver (CA); Ritesh Ahuja, Los Angeles, CA (US); Moein Owhadi Kareshk, Burnaby (CA); Hesam Fathi Moghadam, Sunnyvale, CA (US); Sungpack Hong, Palo Alto, CA (US); Hassan Chafi, San Mateo, CA (US)

(21) Appl. No.: 18/202,472

(22) Filed: May 26, 2023

(51) Int. Cl. G06N 20/00

(52) U.S. Cl. CPC G06N 3/0985; G06N 3/082

(57) ABSTRACT

In an embodiment, a computer combines first original hyperparameters and second original hyperparameters into combined hyperparameters. In each iteration of a binary search that selects hyperparameters, these are selected: a) important hyperparameters from the combined hyperparameters and b) based on an estimated complexity decrease by including only important hyperparameters as compared to the combined hyperparameters, which only one boundary of the binary search to adjust. For the important hyperparameters of a last iteration of the binary search that selects hyperparameters, a pruned value range of a particular hyperparameter is generated based on a first original value range of the particular hyperparameter for the first original hyperparameters and a second original value range of the same particular hyperparameter for the second original hyperparameters. To accelerate hyperparameter optimization (HPO), the particular hyperparameter is tuned only within the pruned value range to discover an optimal value for configuring and training a machine learning model.

### FIELD OF THE INVENTION

The present invention relates to parameter optimization for highly configurable algorithms such as machine learning. Herein combining discrepant performance histories accelerates algorithm parameter tuning.

### BACKGROUND

Computer scientists write algorithms to solve complex problems. Such a problem may be defined as a set of steps that can be repeated until a solution to the problem is found. The creators of these algorithms are faced with several design decisions that influence the performance of the algorithms. To maintain flexibility for reusability, these design decisions are typically deferred and converted into algorithm parameters that can be adjusted to configure the behavior of the algorithm. For example, the training algorithm for the well-known random forest machine learning classifier needs a count of how many decision trees should be trained within the forest, as well as a uniform depth of the trees.

Manually finding suitable (e.g. well tuned or merely tractable) values for all of these parameters can be tedious and time consuming because the configuration space is typically high-dimensional, may be prone to destabilizing discontinuities in any dimension, and may contain constraints between the parameters. It is well known that different problem instances or distributions of problem instances require different parameter configurations for a same reconfigurable algorithm to obtain satisfactory performance in terms of result characteristics such as accuracy or in terms of computer resource consumption such as time and space.

Algorithm configuration procedures automate the tedious task of finding high-quality values for an algorithm's parameters. These parameters control the performance of an algorithm for a given problem instance (or input), but do not affect correctness. Automated algorithm configuration procedures have recently gained substantial attention due to their applicability in a variety of applications. One example optimization problem entails maximizing the predictive accuracy of an automated machine learning (AutoML) pipeline by tuning hyperparameters for configuring and training a machine learning algorithm. Another example optimization problem entails minimizing the running time required by a solver algorithm to solve industrially-relevant nondeterministic polynomial (NP)-hard problems.

Examples of commercially valuable NP-hard problems include graph partitioning, Boolean satisfiability (SAT), the traveling salesperson problem (TSP), and mixed integer programing (MIP). The most popular configuration procedures for these problems are based on strong diversification mechanisms, thereby ensuring that the entire parameter configuration space is adequately explored. The trade-off between exploring and fine-tuning the configuration space is a challenging problem. Meta-heuristic algorithms are known to be effective for optimization problems without closed-form solutions.

A promising approach is to learn from historical performance data to more effectively search for well-performing configurations. However, in practice, historical performance data is heterogeneous, as it may be gathered from evolving codebases, may be evaluated on different problem instances or datasets with different metrics, is scarce, and contains missing values and conditional parameters.

In machine-learning applications, where the machine learning algorithms are also learning to set the values of some parameters (e.g., the weights of a neural network), the parameters used to configure the learning algorithms are typically referred to as hyperparameters. In this context, algorithm configuration is also referred to as hyperparameter optimization (HPO).

State of the art search of a configuration space typically only optimizes for one objective, such as inference accuracy or training time, but not both. Those objectives may be antagonistic to each other such that improved training time degrades accuracy or vice versa. Dynamics such as compensatory parameters, multiple objectives, and antagonistic objectives (i.e. trade-offs) are not well suited to state of the art configuration tuning procedures.

### BRIEF DESCRIPTION OF THE DRAWINGS

In the drawings:

FIG. 1 is a block diagram that depicts an example computer that combines discrepant performance histories to accelerate optimization of configuration parameters of a configurable algorithm;

FIG. 2 is a flow diagram that depicts an example computer process that accelerates optimization of configuration parameters of a configurable algorithm;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is acceleration of hyperparameter optimization (HPO) for machine learning (ML). Novel combining of discrepant training histories accelerates and increases accuracy of training an ML model. This approach is applicable to trainable models and untrainable algorithms. Although ML provides a demonstrative example, any non-ML algorithm that has configurable settings or accepts configurable inputs can be optimized with the approach herein, and this optimization is accelerated in novel ways.

This approach provides complexity reduction of a configuration space that, first, prunes unimportant parameters (e.g. hyperparameters). An unimportant parameter has little or no effect on the outcome of the algorithm. Next is removal of low-quality values from the range of the remaining parameters. This method is based on historical performance data and works when the historical performance data is missing values due to various challenges discussed in the above Background.

Evaluation on natural language processing (NLP) transformer models for text classification shows that evaluating only 500 new configurations on historical datasets is sufficient to accelerate hyperparameter optimization by a multiple compared to using the original, large configuration space. In addition to these running time savings, the importance ranking herein can be used to reveal insights into how an algorithm's parameters impact its performance.

In one example, hyperparameters mean that an artificial neural network may have a reconfigurable count of neural layers and count of neurons per layer, which makes the neural network plastic to be reshaped, retrained, and redeployed for different tasks that have different objectives (e.g. facial recognition versus optical character recognition). A same neural network algorithm may be repeatedly instantiated as distinct ML models, historical data may come from multiple experiments with different objectives, different set of problem instances, or multiple objectives with different scales. Thus, this approach is designed to prune configuration spaces based on multiple collections of historical data without assuming that they share the exact same hyperparameters or the same objectives.

In many practical algorithm configuration scenarios, a goal may be to optimize the performance of the target algorithm in terms of multiple competing performance metrics. For example, in automated ML (AutoML) pipeline scenarios one goal may be to maximize predictive accuracy while minimizing the running time and memory required for inference, and while minimizing the final model's bias with respective to sensitive protected features for fairness.

In multi-objective optimization problems, the goal is to discover and return a frontier of optimal solutions that can be used for trading off between the competing objectives. A particular solution is defined to be Pareto optimal if it has equal or better solution quality with respect to every performance objective and it has strictly better quality with respect to at least one performance objective, when compared with every other candidate solution. The Pareto front is the set of all Pareto optimal solutions. Candidate solutions that are not on the Pareto front are dominated (i.e. outperformed) by at least one Pareto optimal solution.

A configuration space is the set of all possible combinations of values for parameters of an algorithm. The complexity of a configuration space is quantified herein, and a pruned configuration space may be generated and detected as being less complex than an original configuration space. Each parameter provides a distinct dimension in a configuration space and, herein, configuration space complexity is proportional to a count of dimensions (i.e. parameters), and further proportional to the size of value ranges in the dimensions, and further proportional to a count of historical experiments (i.e. trials) that were already recorded in that configuration space.

The primary goal herein is to decrease the configuration space without losing high-quality (e.g. high accuracy, high speed, or small footprint) configurations. The following two observations provide intuition as to how this method achieves this goal.
Unimportant Parameters. The impact of different parameters on the quality is not uniformly important, as there are important and unimportant parameters. That is, various parameters do or do not cause a significant change in the quality of the target algorithm when their value is changed. This observation implies that removing unimportant parameters from the configuration space does not harm the quality of discoverable configurations. However, pruning away unimportant parameters accelerates a configurator by decreasing the complexity of the landscape that is explored.
Low Quality Parameter Values. In the range of candidate values for each parameter, some values cause a lower quality for the target algorithm. Although the position of high-quality values may depend on the assignment of the other parameters, usually there are low-quality values that can be safely pruned away to further decrease the complexity of the landscape that is explored.

This approach discovers and, in an ML embodiment, learns about the unimportant parameters and low-quality values by looking at data from previous configurator runs that shows how well they worked in the past. However, this might be challenging due to the following common cases.
There might be multiple objectives or multiple scales of the same objective in different sources of the performance data;
The configuration space of the different sources of the performance data might not match exactly;
The performance data might have undefined values due to the conditionalities in the configuration space;
The optimal degree of complexity decrease (that is, the maximum shrinkage that can be applied without eliminating the optimal configuration for any future problem scenario) is unknown.

This approach addresses those challenges with the following strategies.
Fill missing values with a special, unseen value that is outside the range of observed values and train decision-tree-based models to predict the performance of unseen configurations. While any machine learning model could be used, it is especially helpful to use a decision-tree-based model, since they can approximate functions with jump discontinuities, which may arise due to how undefined values are handled;
Use the global feature importance of the decision-tree-based model to infer the importance of the parameters;
Decrease the complexity of the configuration space only if all sources of data agree on that specific simplification;
Expose two control settings to the user of the method to control the degree of complexity decrease in the two possible ways; either by pruning unimportant parameters or by pruning low-quality values.

This approach is agnostic to the following components and treats them as opaque (i.e. black box):
A method for ranking the importance of parameters,
A method for taking the union of multiple sets of evaluated configurations and returning a simplified configuration space,
A method to estimate the amount of shrinkage (i.e. complexity decrease),
A method to fill the missing values with values outside of the range of observed values.

In an embodiment, a computer combines first original hyperparameters and second original hyperparameters into combined hyperparameters. In each iteration of a binary search that selects hyperparameters, these are selected: a) important hyperparameters from the combined hyperparameters and b) based on an estimated complexity decrease by including only important hyperparameters as compared to the combined hyperparameters, which only one boundary of the binary search to adjust. For the important hyperparameters of a last iteration of the binary search that selects hyperparameters, a pruned value range of a particular hyperparameter is generated based on a first original value range of the particular hyperparameter for the first original hyperparameters and a second original value range of the same particular hyperparameter for the second original hyperparameters. To accelerate hyperparameter optimization (HPO), the particular hyperparameter is tuned only within the pruned value range to discover an optimal value for configuring and training a machine learning (ML) model.

### 1.0 Example Computer

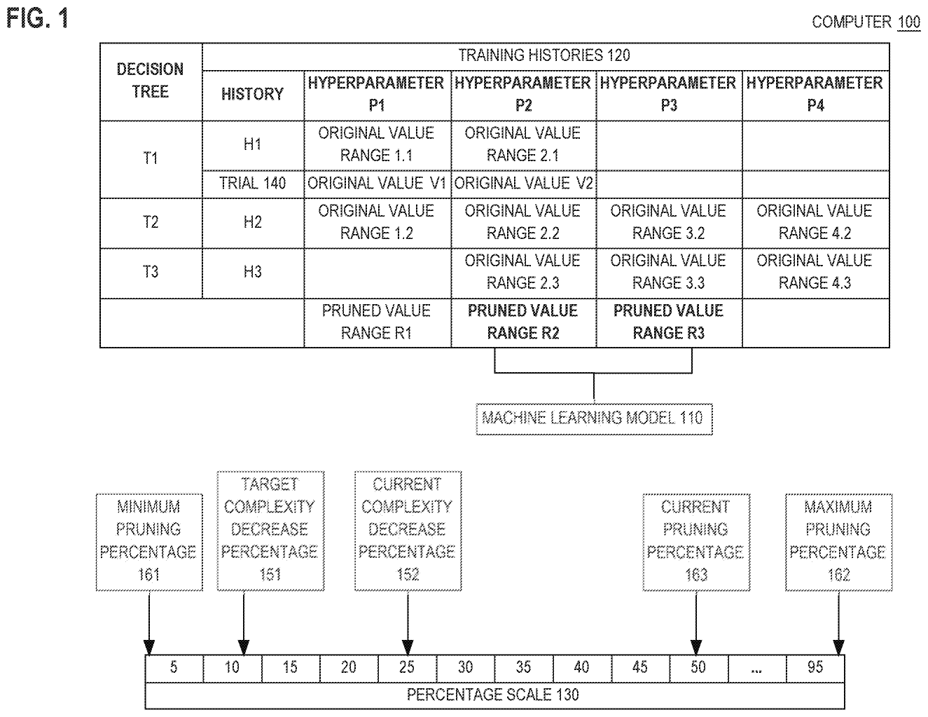

As discussed above, the approach shown in FIG. 1 is applicable to trainable models and untrainable algorithms that likewise are highly configurable. Although machine learning (ML) provides a demonstrative example, any non-ML algorithm that has configurable settings or accepts configurable inputs can be optimized with the approach shown in FIG. 1, and this optimization is accelerated in novel ways. For example as discussed herein, ML model 110 may instead be a non-ML algorithm; training histories 120 may instead be performance histories that did not entail training; and hyperparameters P1-P4 instead are configurable (e.g. injectable) parameters of the non-ML algorithm.

FIG. 1 is a block diagram that depicts an example computer 100, in an embodiment. Computer 100 combines discrepant training histories 120 to accelerate optimization of hyperparameters for ML model 110. Computer 100 may be one or more of a rack server such as a blade, a mainframe, a personal computer, or a virtual machine.

### 1.1 Recorded History of Configurations Tried and Performance Achieved

Training histories 120 contains histories H1-H3 that each contains many performance trials. For example, history H1 contains many performance trials including performance trial 140. Performance trial 140 specifies original values V1-V2 respectively for hyperparameters P1-P2. Performance trial 140 also specifies a fitness (e.g. accuracy) measurement that ML model 110 achieved when configured and trained with the hyperparameters values of that performance trial. Performance trial 140 may optionally identify a training corpus.

ML model 110 may have an evolving codebase and an evolving set of hyperparameters. In this example, histories H1-H2 were recorded for an earlier version of ML model 110's codebase, and history H3 was recorded for a later version of ML model 110's codebase. The earlier and later versions of ML model 110 have partially overlapping respective sets of hyperparameters.

### 1.2 Configurable Parameters

For example in history H2 as shown, the earlier version of ML model 110 was configured with hyperparameters P1-P4. However in history H3 as shown, the later version of ML model 110 was not configured with hyperparameter P1. For example, hyperparameter P1 may be obsolete and unavailable in the later version of ML model 110.

In this example, hyperparameters P3-P4 are optional and used only when hyperparameter P2 has particular value(s), and those values occur in original value ranges 2.2 and 2.3 respectively in histories H2-H3 but not in original values 2.1 in history H1. Thus, hyperparameters P3-P4 are missing values for history H1 as shown.

### 1.3 Combined Parameters

In this example, it is incidental that history H2 has an original value range for all hyperparameters P1-P4. In other examples, there might be no individual history that has an original value range for all hyperparameters. Hyperparameters P1-P4 are a combined plurality of hyperparameters that computer 100 identifies as the union of all hyperparameters used in all histories H1-H3. For example, the combined hyperparameters would still include hyperparameters P1-P4 even if training histories 120 did not contain history H2.

In this example and as discussed later herein, computer 100 selects hyperparameters P1-P3 as important enough to need tuning (i.e. optimization) and, for acceleration, unimportant hyperparameter P4 is not selected and not tuned. As discussed later herein, computer 100 calculates pruned value ranges R1-R3 respectively for tuning important hyperparameters P1-P3 and, for acceleration, values outside of pruned value ranges R1-R3 are not used for tuning important hyperparameters P1-P3. In those two ways, hyperparameter optimization (HPO) is accelerated beyond the state of the art as discussed later herein.

As discussed above, history H3 used the newer version of machine learning (ML) model 110's codebase, and that version lacks now obsolete hyperparameter P1. Computer 100 can designate hyperparameters P1-P3 as important and generate pruned value range R1 as shown in FIG. 1, which will optimize including obsolete hyperparameter P1. If the target codebase version of ML model 110 is the same as was used in histories H1-H2, then obsolete hyperparameter P1 can be treated as important to generate pruned value range R1 as shown in FIG. 1.

If the target codebase version of ML model 110 instead is the same as was used in history H3, then obsolete hyperparameter P1 can be treated as unimportant and only pruned value ranges R2-R3 are generated and shown bold in FIG. 1. In an embodiment, the target codebase version is not considered for complexity reduction herein, and all pruned value ranges R1-R3 are generated. Later invocations of an ML pipeline for particular instances of ML model 110 may reuse particular subsets of already calculated pruned value ranges R1-R3, such as only R2-R3 shown bold.

### 1.4 Quantifiable Complexity of Configuration Space

As discussed later herein, each of histories H1-H3 has a respective quantifiable complexity. Empirical measurement of the complexity of, for example, history H1 is: a) neither measured nor used herein, b) measured as elapsed training duration(s), and c) optionally already recorded in the performance trials in history H1. Complexity measurement herein is by estimation calculation and, as discussed later herein, is decreased when the count of hyperparameters decreases or when the value range of a hyperparameter decreases. Complexity can be estimated for: a) any of histories H1-H3 that are historical configuration spaces or b) a new pruned configuration space that contains, for example, only pruned value ranges R1-R3 and only important hyperparameters P1-P3.

A complexity improvement herein is a percent decrease in complexity, such as a ten percent decrease. Herein, complexity improvement and complexity decrease are synonymous. A complexity decrease may be any percent value in percentage scale 130 that ranges from zero percent to a hundred percent.

Target complexity decrease percentage 151 may be provided by a user, such as ten percent. In one scenario, target complexity decrease percentage 151 is a percent decrease in complexity from an original configuration space (e.g. history H1) to a new configuration space that is pruned to exclude unimportant hyperparameters. In another scenario, target complexity decrease percentage 151 instead is a percent decrease in complexity from that pruned configuration space to another new configuration space that is further pruned to a pruned value range as explained later herein.

### 1.5 Complexity Comparison Between Configuration Spaces

The important hyperparameters and the pruned value ranges are two distinct prunings, and either pruning may be provided a respective value of target complexity decrease percentage 151. In other words, both prunings separately invoke a same complexity improvement calculation. An embodiment may use the following example complexity improvement formula.

$${C}_{grid} ( {H}^{′} , H ) = \frac{{\sum }_{h ∈ {H}^{′}} \vert h \vert}{{\sum }_{h ∈ H} \vert h \vert} \times \frac{{( {\sum }_{h ∈ H} \vert h \vert )}^{\frac{\vert params ( {H}^{′} ) \vert}{\vert params ( H ) \vert}}}{{\sum }_{h ∈ H} \vert h \vert}$$

As explained above, target complexity decrease percentage 151 may occur for two different scenarios. For a first scenario that prunes by decreasing dimensionality (i.e. count of hyperparameters) of the configuration space, in the above example complexity improvement formula, the following inputs have the following meanings.
His training histories 120 (i.e. histories H1-H3).
H′ is a pruned configuration space based on H, in which only important hyperparameters P1-P3 are included with their original value ranges.

For a second scenario that prunes by decreasing cardinality (i.e. count of performance trials) of the configuration space, in the above example complexity improvement formula, the following inputs instead have the following meanings.
H is above H′ from the above first scenario.
H′ is a further pruned configuration space based on above H′ and pruned value ranges R1-R3.

In the above example complexity improvement formula, the following terms have the following meanings.
h is an individual configuration space such as an individual history (e.g. H1) or a pruned version of the individual history.
   |h| is the cardinality of that configuration space, which is a count of performance trials in that configuration space. Because some performance trials may be pruned away, the cardinality of H′ may be less than or equal to the cardinality of H.
   |params (H)| is the dimensionality of that configuration space, which is a count of hyperparameters in that configuration space, which is all hyperparameters P1-P4 for the original configuration space, or is only the important hyperparameters for a pruned configuration space.

The above example complexity improvement formula returns a calculated complexity improvement, which is a percentage of complexity decrease ranging from zero for no decrease to a hundred, which is an ideal that rarely is achieved when a pruning prunes away all trials or all hyperparameters of a configuration space. Thus, target complexity decrease percentage 151 is shown as a percent value such as ten percent in percentage scale 130 from zero to a hundred.

### 1.6 Pruning Away Unimportant Hyperparameters

From percentage scale 130, a user may provide a particular value for target complexity decrease percentage 151. For example if the user specifies that target complexity decrease percentage 151 is ten percent, then that may require selecting unimportant hyperparameters to prune away. Pruning away an unimportant hyperparameter that all histories H1-H3 have original values for is likely to provide more complexity improvement than pruning away a hyperparameter that few histories have original values for.

Thus, how much complexity improvement is achieved depends on which unimportant hyperparameter(s) are pruned away, and the magnitude of the complexity improvement does not depend on the relative importance (e.g. importance rank or score) of the hyperparameters. For example, pruning away two unimportant hyperparameters might provide more or less than twice the complexity improvement of pruning away only one of those two hyperparameters. Thus it may be somewhat unpredictable as to how many unimportant hyperparameters will be pruned away to achieve target complexity decrease percentage 151 as specified by the user. For example, target complexity decrease percentage 151 being ten percent does not mean that ten percent of the hyperparameters should be pruned away.

### 1.7 First Binary Search to Decrease Dimensionality

Complexity improvement is not the only kind of percentage whose values may occur in percentage scale 130. Percentage scale 130 is a generalization of any kind of percentage, because all percentages involve a scale from zero to a hundred by definition. Another kind of percentage is a percent decrease in hyperparameters.

As discussed earlier herein, a ten percent decrease in complexity is not the same thing as a ten percent decrease (i.e. pruning) of dimensionality (i.e. count of hyperparameters). Thus, complexity decrease percentages 151-152 are not the same kind of percentages as (e.g. hyperparameter) pruning percentages 161-163, even though all of percentages 151-152 and 161-163 are percentages in same percentage scale 130.

Computer 100 performs either or both of the following two binary searches within percentage scale 130. Percentage scale 130 is shown with an ellipsis between 50 and 95, which indicates that all values between 50 and 95 are implied but not shown. Herein, percentage scale 130 is demonstrative (i.e. implied) and not actually stored or operated in computer 100. However, percentages 151-152 and 161-163 are numeric variables that are stored and operated (e.g. adjusted) in computer 100 as follows.

Computer 100 may perform either or both of a first binary search to detect how many unimportant hyperparameters to prune to decrease dimensionality of a configuration space and a second binary search to narrow value ranges by decreasing cardinality of a configuration space. Each of both binary searches maintains (e.g. adjusts) its own instances of percentages 151-152 and 161-163. For example for the two binary searches, there may be two instances of target complexity decrease percentage 151 as discussed earlier herein.

In an embodiment, the first binary search finishes before the second binary search starts, in which case the second binary search may reset and reuse a same set of instances of percentages 151-152 and 161-163. For example, minimum pruning percentage 161 may be reset to zero at the start of each of both binary searches.

The first binary search discovers how many of the least important features should be pruned away. In either binary search, minimum pruning percentage 161 is initially zero, and maximum pruning percentage 162 is initially a hundred as shown. Each iteration of the first binary search detects which only one of pruning percentages 161-162 should be adjusted to be nearer to the other (i.e. unadjusted) pruning percentage. Thus, both pruning percentages may iteratively move nearer towards each other until they converge, which is when iteration ceases and the binary search ceases.

In either binary search, current pruning percentage 163 is reassigned (i.e. adjusted) in each iteration to be the arithmetic midpoint between pruning percentages 161-162. Thus, current pruning percentage 163 is initially fifty percent as shown. For example in the first binary search, current pruning percentage 163 being fifty percent means that half of all hyperparameters P1-P4 are pruned away in the current iteration, which is very aggressive (e.g. excessive).

The estimated complexity improvement of pruning away half of the hyperparameters in the first iteration is current complexity decrease percentage 152 that is 25 percent as shown, which is excessive because it exceeds target complexity decrease percentage 151 that is ten percent. For example, current complexity decrease percentage 152 may be calculated by the example complexity improvement formula presented earlier herein.

Detection of which only one of pruning percentages 161-162 needs adjusting in the current iteration is based on detecting whether current complexity decrease percentage 152 is less than or greater than target complexity decrease percentage 151. In this example first iteration, current complexity decrease percentage 152 is excessive, which means that maximum pruning percentage 162 should be reassigned the same value as current complexity decrease percentage 152. Otherwise, minimum pruning percentage 161 should be reassigned the same value as current complexity decrease percentage 152.

As explained earlier herein, current pruning percentage 163 is reassigned at the start of each iteration to be the arithmetic midpoint between pruning percentages 161-162 as adjusted by the previous iteration. Thus, a second iteration may operate in a same way as the first iteration as discussed above. In that way, either binary search may iteratively operate.

### 1.8 Second Binary Search to Decrease Cardinality

In the first binary search, each of pruning percentages 161-163 is a percent of hyperparameters to be pruned away as unimportant based on lowest ranking (e.g. lowest importance scores). In the second binary search, each of pruning percentages 161-163 is instead a percent of performance trials to prune away from each of histories H1-H3 based on lowest (i.e. worst) fitness scores as recorded in the performance trials. For example, whether performance trial 140 is or is not pruned from history H1 in the current iteration of the second binary search depends on the fitness score of performance trial 140 and on current pruning percentage 163.

In both binary searches, current pruning percentage 163 might not be monotonically adjusted. For example, current pruning percentage 163 may increase in a previous iteration, decrease in a current iteration, and then increase again in a next iteration. Thus, current pruning percentage 163 may iteratively fluctuate in both directions. A consequence of nonmonotonic fluctuation of current pruning percentage 163 is that: a) in the first binary search, a hyperparameter may fluctuate back and forth between pruned (i.e. unimportant) and not pruned (i.e. important), and b) in the second binary search, a performance trial may fluctuate back and forth between pruned and not pruned.

The only shown percentage that is fixed (i.e. does not fluctuate) during either binary search is target complexity decrease percentage 151. Despite possibly fluctuating in both directions during either binary search, the following shown percentages will have the following values when the binary search finishes (i.e. ceases iterating due to convergence): a) pruning percentages 161-163 have identical or somewhat similar values, and b) complexity decrease percentages 151-152 are identical.

### 1.9 Example Binary Search Pseudocode

The following example binary search pseudocode performs both binary searches using the following example data structures.
A history (e.g. history H1) is a set of tuples corresponding to the trials performed in some previous configurator runs. Each tuple (e.g. performance trial 140) contains a configuration and its corresponding solution quality value (i.e. performance score). For a history, h, |h| is the cardinality (i.e. number of trials) of that history.
A configuration space is a relation from hyperparameters (e.g. hyperparameter P1) to their ranges of permissible values (e.g. value range 1.1 or R1).
The function params returns the set of hyperparameters evaluated in the configuration space that was evaluated in a history, set of histories, or in a configuration space.

In this example, parameter means hyperparameter, and shrinkage means percent decrease. The following example binary search pseudocode accepts the following inputs.
Shrinkage by parameters, S!, a real number in the range (0, 1]. For example, a value of 0.1 will reduce the space by 10% of the original number of parameters. This is target complexity decrease percentage 151 for the first binary search.
Shrinkage by values, S″, a real number in range (0, 1]. For example, a value of 0.2 will reduce the ranges of the remaining parameters by 20% of their original ranges, on average. This is target complexity decrease percentage 151 for the second binary search.
Complexity heuristic, C(⋅,⋅), a function that maps from two sets of histories to real numbers, estimating the relative complexity of the two configuration spaces. This may be the example complexity improvement formula earlier herein.
Performance data, H a set of histories. These are histories H1-H3.
Normalizer, N(⋅), is a function that normalizes a set of histories to have a common set of parameters, with undefined values imputed (i.e. set) to a single, arbitrary unseen value for each parameter.
Parameter importance, R(⋅), a function that returns the importance ranking of parameters in a history.
Union function, U(⋅), that returns a configuration space that includes all the configurations within a given set of histories.

The following example binary search pseudocode returns pruned configuration space, H′, including only the important hyperparameters and their high-quality value ranges such as pruned value ranges R1-R3. The following example binary search pseudocode has the following steps 1-4 and sub-steps.

```
1. H# = N(H)
2. Prune the unimportant parameters
  a. Set l = 0%, u = 100%, these are the bounds for a binary search,
  $b . Set α = \frac{l + u}{2} \text{this is the internal cut‐off threshold to tune to achieve a shrinkage,}$
  c. Set P = { }, before populating this set with the important parameters from each
  history,
  d. For each history, h ∈ H
    i. Set k = ┌α × |params(h)|┐, where params(h) returns the list of
    parameters in h.
    ii. P = P ∪ {top k parameters according to R(h)}
  e. Set H( to a transformation of H# that has all of the parameters not in P
  fixed to their default values
  f. If C(H(, H#) > (1 − S!), i.e. the complexity of H( relative to H# is more than the
  desired complexity:
    i. Set u = α
  g. Else
    i. Set l = α
  h. If P is different from its value in the previous iteration, go to step b.
    i. Set H! = H(
3. Prune the low-quality values
  a. Set l = 0%, u = 100%, these are the bounds for a binary search,
  $b . Set α = \frac{l + u}{2} \text{this is the internal cut‐off threshold to tune to achieve a shrinkage,}$
  c. Set S( = { }, before populating this space with the high-quality values from each
  history,
  d. For each history, h ∈ H
    i. Set k = ┌α × |h|┐
    ii. S( = ∪ ({S), {best k trials in h}})
  e. Set H( to the set of transformed histories in H! that only includes trials within S(
  f. If C(H(, H!) > (1 − S″), i.e. the complexity of H( relative to H! is more than the
  desired complexity:
    i. Set u = α
  g. Else
    i. Set l = α
  h. If H( is different from the previous iteration, go to step c.
    i. Set H′ to the set of transformed and filtered histories in H( that only
    includes the parameters in P.
4. Return H′|
```

In the above pseudocode, step 2 is the first binary search that improves complexity by decreasing dimensionality to prune a configuration space, and step 3 is the second binary search that improves complexity by decreasing cardinality to prune the configuration space. In the above pseudocode, the following internal variables have the following meanings.
l is minimum pruning percentage 161,
u is maximum pruning percentage 162.
α is current pruning percentage 163.

### 2.0 Example Configuration Space Pruning Process

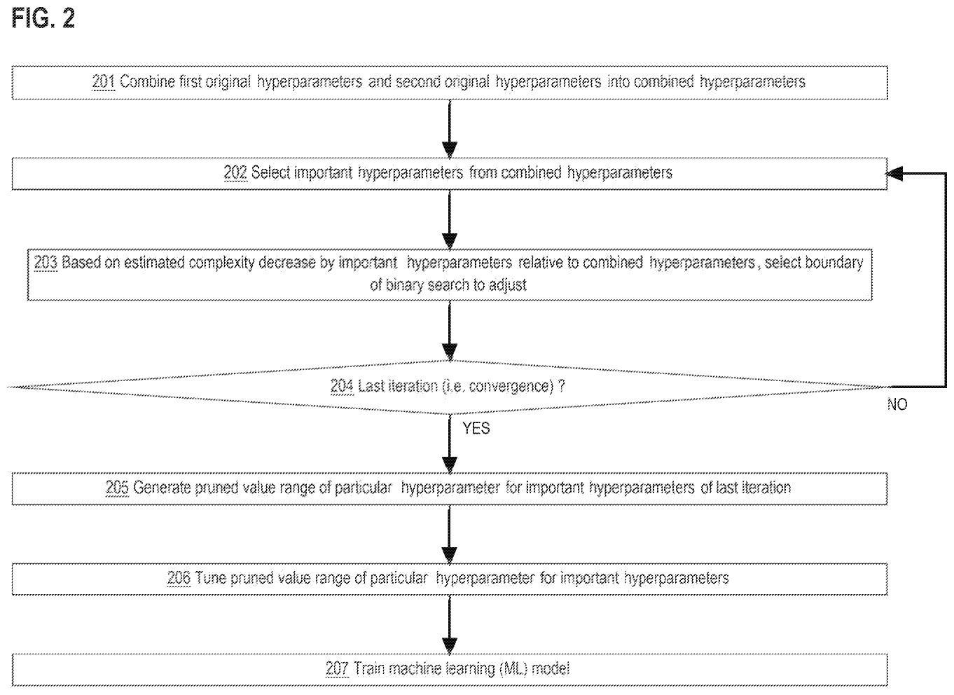

FIG. 2 is a flow diagram that depicts an example process that computer 100 may perform to combine discrepant training histories 120 to accelerate optimization of hyperparameters P1-P3 for machine learning (ML) model 110. The above example binary search pseudocode may be an implementation of the process of FIG. 2. FIG. 2 is discussed with reference to FIG. 1 and the above example binary search pseudocode.

Into combined hyperparameters, preparatory step 201 combines the original hyperparameters of all histories H1-H3 including, for example, hyperparameters P1-P2 of history H1 as first original hyperparameters and hyperparameters P2-P4 of history H3 as second original hyperparameters. Step 201 is step 1 in the above example binary search pseudocode that invokes normalizer, N(⋅) that is a function that normalizes a set of histories to have a common set of hyperparameters (e.g. P1-P4), with undefined values set to a single, arbitrary unseen value for each hyperparameter. An unseen value is a value that never occurs in training histories 120 for a particular hyperparameter.

Normalizer, N(⋅), is a function that accepts as input the union of existing hyperparameters among the histories and adds non-existing hyperparameters as undefined for the histories that have missing hyperparameters. Then, the normalizer fills the undefined values with a special value for categorical parameters and with min(values)−1 for the numerical hyperparameters, where the values are all the observed values for that hyperparameter in training histories 120.

Step 2 in the above example binary search pseudocode is the first binary search, which improves complexity by decreasing dimensionality to prune a configuration space. Steps 202-204 occur in each iteration of the first binary search (i.e. step 2).

Step 202 selects important hyperparameters for the current iteration from combined hyperparameters P1-P4. As explained earlier herein, across several iterations of the first binary search, a hyperparameter may fluctuate back and forth between pruned and not pruned (i.e. important). Step 202 may perform above sub-steps 2(b-d), where P is the important hyperparameters. Step 202 adjusts current pruning percentage 163 during the first binary search.

Based on current complexity decrease percentage 152 that is estimated for important hyperparameters relative to combined hyperparameters, step 203 selects which only one boundary of the first binary search to adjust. Step 203 may use the earlier herein example complexity improvement formula to calculate current complexity decrease percentage 152 per above sub-step 2(f). Step 203 selects only one of pruning percentages 161-162 to adjust as discussed earlier herein.

Step 204 detects whether or not the first binary search has converged. Thus, step 204 decides whether or not the current iteration is the last iteration of the first binary search. The last iteration is important because the results of the last iteration will be used as the results of the first binary search. If convergence is absent, then the current iteration is not the last iteration, and a next iteration begins by repeating step 202.

If convergence occurs, then the first binary search ceases and step 205 occurs. Step 205 generates pruned value ranges R1-R3 of important hyperparameters P1-P3 that were selected in the last iteration. Step 205 performs the second binary search that improves complexity by decreasing cardinality to prune the configuration space as discussed earlier herein. Step 205 may be above step 3.

Step 206 tunes pruned value ranges R1-R3 for important hyperparameters P1-P3. Step 206 may use an open source hyperparameter optimization (HPO) tool such as hyperopt. However, step 206 is accelerated over the state of the art because step 206 does not use the original configuration spaces of histories H1-H3, which would be too slow. Instead, step 206 uses the pruned configuration space as pruned by both binary searches, which provides acceleration. The result of step 206 is optimal values for hyperparameters P1-P3 of machine learning (ML) model 110.

Step 207 uses those optimal values for hyperparameters P1-P3 to configure and train ML model 110, after which ML model 110 is ready to be deployed for production use.

### 3.0 Infrared Importance Scores for Ranking Hyperparameters

The following discussion regards FIG. 1. As explained earlier herein, the first binary search is based on an importance ranking of all hyperparameters P1-P4, which may or may not be based on numeric importance scores. In an optional embodiment, numeric importance scores of hyperparameters are derived by inspection or analysis of decision trees T1-T3 that are weak learners in an ensemble of trees. Decision trees T1-T3 are optional and not implemented in some embodiments. In an embodiment not shown, the ensemble of trees is a random forest.

In the shown embodiment, the ensemble instead has a respective distinct decision tree for each of histories H1-H3. For example, decision tree T2 is trained only with history H2, and history H2 is not used to train other decision trees T1 and T3. In that case, decision trees T1-T3 have separate distinct training corpuses that are disjoint (i.e. nonoverlapping). For example because performance trial 140 is contained in history H1, performance trial 140 is not training input for other decision trees T2-T3. Ensemble training occurs before the binary searches.

Supervised training of decision trees T1-T3 uses the fitness scores as labels, which were already recorded in the performance trials. In that way, decision tree T1 functions as a trainable numeric regression that learns to predict fitness scores. For example in training, decision tree T1 may be invoked to predict the fitness score of performance trial 140. In that case, decision tree T1 accepts as input a feature vector that contains original values V1-V2 respectively for hyperparameters P1-P2, which causes decision tree T1 to infer (i.e. predict) a fitness score for that input. In other words, each of hyperparameters P1-P2 is encoded as a respective feature in the feature vector. The predicted fitness score is an estimate of a fitness score that ML model 110 would achieve if configured with original values V1-V2 respectively for hyperparameters P1-P2.

Feature metrics such as Gini impurity or entropy may be measured for hyperparameters P1-P2 in history H1, and those metrics may be used to construct and configure (i.e. train) decision tree T1. As discussed above, each of hyperparameters P1-P2 is treated as a distinct feature, which may be leveraged in the following ways in the following feature-based embodiments.

In one feature-based embodiment, a feature measurement such as impurity that is used to train decision tree T1 is also directly reused as the importance score of a hyperparameter. However, impurity may be specific to decision trees (i.e. tree models). Another feature-based embodiment instead may be model-agnostic, in which case decision trees T1-T3 may be implemented or unimplemented, in which case another kind of ensemble or kind of individual ML model might instead be implemented.

In feature-based model-agnostic embodiment, feature attribution based on metalearning and/or interpolation may provide hyperparameter importances. As discussed earlier herein, whether performance trial 140 is or is not pruned from history H1 in the current iteration of the second binary search depends on the fitness score of performance trial 140 and on current pruning percentage 163.

Histories H1-H3 may have been automatically generated during state of the art hyperparameter optimization (HPO), such as in an AutoML pipeline. HPO is naturally biased (e.g. greedy gradient descent) towards fit configurations, which may cause many performance trials in fit regions of the configuration space and few performance trials in the unfit regions. That bias may cause a class imbalance where unfit performance trials are an underrepresented minority class. To decrease class imbalance, new unfit performance trials may be synthesized by interpolation of values of hyperparameters that would decrease the accuracy of ML model 110.

As discussed earlier herein, implementation of any ensemble or model for obtaining hyperparameter importances is optional. In an embodiment lacking that optional implementation, ML model 110 is the only implemented ML model, and neither binary search entails training or validating. In that case, target complexity decrease percentage 151 is predefined (e.g. hard coded) or provided by the user.

### 3.1 Automatically Calculating Target Improvement

In the following optional embodiment, target complexity decrease percentage 151 is instead automatically optimized as follows. The ensemble (e.g. decision trees T1-T3) or opaque (i.e. black box) ML model is trained to predict performance scores as discussed above, and global feature attribution is used to obtain hyperparameter importances. As follows, a grid search discovers experimental target complexity decrease percentages that should not be empirically evaluated (i.e. fitness scoring) using ML model 110, which would be too slow.

Instead, decision trees T1-T4 each predict a respective fitness score for a same grid point (i.e. an experimental target complexity decrease percentage), and the average of those predicted scores is used as the estimated fitness score for that experimental percentage. This entails a two-dimensional grid (not shown) because, as explained earlier herein, target complexity decrease percentage 151 may have two values respectively for two binary searches. The grid search (i.e. automatic optimization of target complexity decrease percentage 151) occurs once, which is after training the ensemble and before the binary searches.

The following example grid search pseudocode accepts the following inputs.

| | |
|---|---|
| • | Histories H1-H3 of evaluated configurations for each dataset, dataset_histories |
| • | Hyperparameters P1-P4 and their original value ranges as the original configuration |
| | space, config_space |
| • | Decision trees T1-T3, each an ML model trained to predict the performance of configs on |
| | a history (one for each of histories H1-H3), performance_predictors |
| • | A predefined (e.g. hard coded) or user-specified maximum allowable performance |
| | degradation (as a percentage, e.g. 0.05), eps |
| • | Number of meta-dataset cross validation folds, k |
| • | Percentage of configurations used to estimate quality of best configs, elitism_rate |
| • | Number of grid points on each axis of the grid to try for the shrinkage by parameters and |
| | values, n_thresholds |
| • | Earlier herein, the example complexity improvement formula as a method for calculating |
| | the amount of shrinkage obtained, reduction_factor |

The above input elitism_rate is not part of a genetic algorithm, and the following example grid search pseudocode lacks random mutation. The above input k is for cross validation, but the following example grid search pseudocode does no empirical evaluation and does not use ML model 110, which would be too slow.

The following example grid search pseudocode returns the following outputs.
For a first binary search to decrease dimensionality as discussed earlier herein, a first value of target complexity decrease percentage 151
For a second binary search to decrease cardinality as discussed earlier herein, a second value of target complexity decrease percentage 151
Predicted score reduction
Estimated range reduction

The following is the example grid search pseudocode that has the following steps 1-8 and sub-steps.

| | |
|---|---|
| 1. | Initialize an empty list grid. |
| 2. | Loop through the array of evenly spaced numbers between 0 and 1 with n_thresholds |
| | elements as reduction_hps. |
| 3. | Inside the first loop, loop through the array of evenly spaced numbers between 0 and 1 |
| | with n_thresholds elements as reduction_ranges. |
| 4. | Initialize an empty list score_degradations and reduction_factors. |
| 5. | Loop through k-fold splits of dataset_histories and for each train_datasets and |
| | val_datasets pair, do the following: |

| | |
|---|---|
| a. | Apply reduction to train_datasets using reduction_hps and |
| | reduction_ranges and get the reduced configuration space. |
| b. | Select the top elitism_rate configurations on val_datasets and store them as |
| | elite_configs. |
| c. | Calculate the original score by taking the mean of performance predictors for |
| | elite_configs. |
| d. | Create a deep copy of elite_configs and modify it as follows: |

| | |
|---|---|
| i. | If a hyperparameter is not in the reduced configuration space, set its value |
| | to its default value. |
| ii. | If a hyperparameter is in the reduced configuration space but the value of |
| | elite_configs is not in its range, clip the value to the range. |

| | |
|---|---|
| e. | Calculate the reduced score by taking the mean of performance predictors for |
| | elite_configs_cp. |
| f. | Calculate the score degradation as the minimum of |
| | reduced_score/original_score and 1. |
| g. | Calculate the reduction factor using reduced_config_space and |
| | config_space. |
| h. | Append the score degradation and reduction factor to score_degradations and |
| | reduction_factors respectively. |

| | |
|---|---|
| 6. | Append a dictionary with reduction_hps, reduction_ranges, score_degradation, |
| | and reduction_factor to grid. |
| 7. | Filter the entries of grid such that score_degradation is greater than 1 - eps and store |
| | the result in acceptable_reductions. |
| 8. | Find the entry in acceptable_reductions with the maximum reduction_factor and |
| | return its contents |

### 4.0 Principal Component Analysis (PCA)

In this optional feature-based embodiment, both binary searches use a synthetic configuration space that principal component analysis (PCA) generates from the original configuration space. Hyperparameters P1-P4 are treated as original features by the PCA. Earlier herein normalizer N may be enhanced to perform PCA to generate and return a synthetic configuration space that, as follows, may have less complexity than whichever configuration space the normalizer would have returned without PCA. For example, preparatory step 201 may perform PCA to generate and use synthetic features (i.e. principal components) from original features (i.e. hyperparameters P1-P4), and those synthetic features are the dimensions of the synthetic configuration space.

Although generated and processed by PCA as synthetic features, these effectively are synthetic hyperparameters. Each synthetic hyperparameter is based on all original hyperparameters P1-P4 because PCA generates each synthetic feature from all original features. Thus, PCA can generate fewer synthetic features than original features, which means there may be fewer synthetic hyperparameters than original hyperparameters.

Thus, the synthetic configuration space may be smaller (i.e. have fewer dimensions) than an original configuration space. In that way and because PCA occurs before the binary searches, PCA decreases dimensionality, which accelerates both binary searches. After the binary searches and before tuning step 206, the PCA is reversed to convert (i.e. project) the pruned PCA configuration space into a pruned original configuration space that tuning step 206 can use.

In various embodiments, the principal components are generated based on all performance trials of all histories H1-H3 or, preferably, based on half or less of the performance trials that have the highest fitness scores. For example, whether generation of principal components is or is not based on performance trial 140 depends on the fitness score of performance trial 140 and a (e.g. predefined) threshold percentage of best performance trials to use. For example, the threshold percentage may be thirty percent. The threshold percentage is only used when generating principal components. The threshold percentage is not target complexity decrease percentage 151 that instead is used only during the binary searches.

In any case, the synthetic features are less correlated than hyperparameters P1-P4. For example as discussed earlier herein, hyperparameters P3-P4 may be optional and used only when hyperparameter P2 has particular value(s). In that case, hyperparameters P3-P4 are correlated with hyperparameter P2. In a different correlation example, cake baking parameters may include oven temperature and baking duration that are compensatory such that more temperature may compensate for less time or vice versa.

Correlations between hyperparameters decelerate tuning step 206 by causing redundant (i.e. correlated) calculations. Thus, removal of correlations by PCA provides acceleration. PCA and principle component projection are taught in “Principal Component Analysis” published in 1987 by Svante Wold et al in Chemometrics and Intelligent Laboratory Systems, volume 2, numbers 1-3 that is incorporated by reference herein in its entirety.

Although PCA prioritizes generation of synthetic features whose eigenvectors have the highest eigenvalues, novel feature attribution herein may instead, in an optional embodiment, calculate and use importance scores for synthetic hyperparameters (i.e. synthetic features) and those importance scores may be calculated as inversely proportional to the eigenvalue of the eigenvector of the synthetic hyperparameter. A low eigenvalue indicates uncorrelated original hyperparameters that deserve high importance scores because, as explained above, correlation means somewhat redundant (i.e. unimportant) original hyperparameters. Correlation implies a flat (i.e. low gradient) spatial mapping of correlated original hyperparameters to fitness scores of performance trials. Tuning step 206 exploring flatness in a configuration space is slow, and it is wasteful for step 206 to seek a (i.e. non-existent) peak (i.e. optimum) in flatness. Thus unlike state of the art PCA that selects principal components (i.e. synthetic features) that have high eigenvalues, this novel feature attribution instead selects synthetic hyperparameters that have low eigenvalues.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

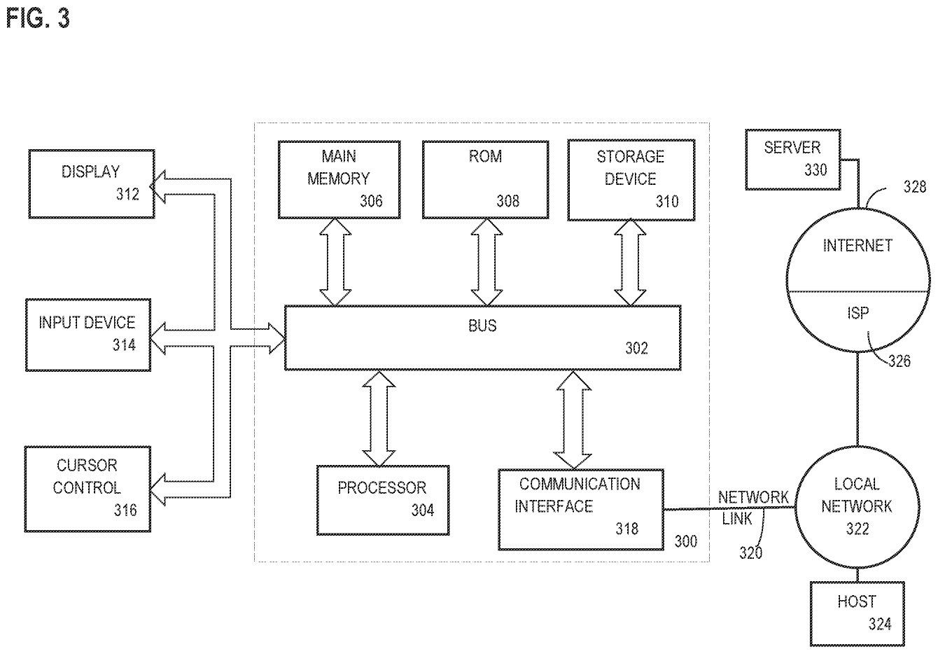

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

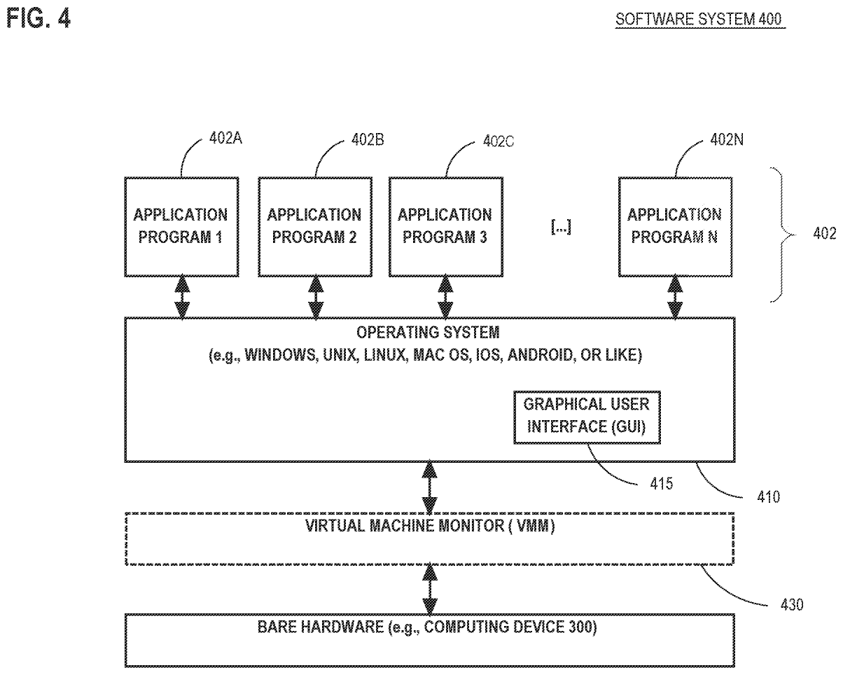

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
combining, into a combined plurality of hyperparameters, a first original plurality of hyperparameters and a second original plurality of hyperparameters;
selecting in each iteration of a binary search that selects hyperparameters:
a) an important plurality of hyperparameters from the combined plurality of hyperparameters, and
b) based on an estimated complexity decrease by the important plurality of hyperparameters relative to the combined plurality of hyperparameters, a boundary of the binary search to adjust;
generating, for the important plurality of hyperparameters of a last iteration of the binary search that selects hyperparameters, a pruned value range of the hyperparameter that is based on a first original value range of a hyperparameter for the first original plurality of hyperparameters and a second original value range of said hyperparameter for the second original plurality of hyperparameters;
tuning the pruned value range of the hyperparameter for the important plurality of hyperparameters; and
training, based on said tuning, a machine learning (ML) model;
wherein the method is performed by one or more computers.

2. The method of claim 1 wherein said binary search does not comprise training nor validating.

3. The method of claim 1 wherein in a first iteration of said binary search, the first original plurality of hyperparameters contains a particular hyperparameter that the important plurality of hyperparameters of the first iteration does not contain.

4. The method of claim 3 further comprising selecting the particular hyperparameter based on a trainable regression that predicts a fitness of the ML model.

5. The method of claim 4 further comprising supervised training the trainable regression based on the first original plurality of hyperparameters and the second original plurality of hyperparameters.

6. The method of claim 5 wherein said supervised training the trainable regression comprises interpolating values of hyperparameters that would decrease the accuracy of said ML model.

7. The method of claim 4 further comprising:
calculating, based on the trainable regression that predicts the fitness of the ML model, an improvement threshold;
said selecting the boundary of the binary search to adjust is based on the improvement threshold.

8. The method of claim 4 wherein the trainable regression comprises a first decision tree for the first original plurality of hyperparameters and a second decision tree for the second original plurality of hyperparameters.

9. The method of claim 1 wherein the important plurality of hyperparameters in a first iteration of said binary search contains a particular hyperparameter that the first original plurality of hyperparameters does not contain.

10. The method of claim 9 further comprising imputing a new value for the particular hyperparameter that is outside of a value range of the particular hyperparameter.

11. The method of claim 9 wherein the second original plurality of hyperparameters and the important plurality of hyperparameters of the first iteration contain the particular hyperparameter.

12. The method of claim 1 wherein said combining into the combined plurality of hyperparameters comprises generating, by principal component analysis (PCA), the combined plurality of hyperparameters.

13. One or more non-transitory computer-readable media storing instructions that, when executed by one or more processors, cause:
combining, into a combined plurality of hyperparameters, a first original plurality of hyperparameters and a second original plurality of hyperparameters;
selecting in each iteration of a binary search that selects hyperparameters:
a) an important plurality of hyperparameters from the combined plurality of hyperparameters, and
b) based on an estimated complexity decrease by the important plurality of hyperparameters relative to the combined plurality of hyperparameters, a boundary of the binary search to adjust;
generating, for the important plurality of hyperparameters of a last iteration of the binary search that selects hyperparameters, a pruned value range of the hyperparameter that is based on a first original value range of a hyperparameter for the first original plurality of hyperparameters and a second original value range of said hyperparameter for the second original plurality of hyperparameters;
tuning the pruned value range of the hyperparameter for the important plurality of hyperparameters; and
training, based on said tuning, a machine learning (ML) model.

14. The one or more non-transitory computer-readable media of claim 13 wherein said binary search does not comprise training nor validating.

15. The one or more non-transitory computer-readable media of claim 13 wherein in a first iteration of said binary search, the first original plurality of hyperparameters contains a particular hyperparameter that the important plurality of hyperparameters of the first iteration does not contain.

16. The one or more non-transitory computer-readable media of claim 15 wherein the instructions further cause selecting the particular hyperparameter based on a trainable regression that predicts a fitness of the ML model.

17. The one or more non-transitory computer-readable media of claim 16 wherein the instructions further cause:
calculating, based on the trainable regression that predicts the fitness of the ML model, an improvement threshold;
said selecting the boundary of the binary search to adjust is based on the improvement threshold.

18. The one or more non-transitory computer-readable media of claim 16 wherein the trainable regression comprises a first decision tree for the first original plurality of hyperparameters and a second decision tree for the second original plurality of hyperparameters.

19. The one or more non-transitory computer-readable media of claim 13 wherein the important plurality of hyperparameters in a first iteration of said binary search contains a particular hyperparameter that the first original plurality of hyperparameters does not contain.

20. The one or more non-transitory computer-readable media of claim 13 wherein said combining into the combined plurality of hyperparameters comprises generating, by principal component analysis (PCA), the combined plurality of hyperparameters.
